(19) United States
(12) Patent Application Publication
(10) Pub. No.: US 2023/0052008 A1
(43) Pub. Date: Feb. 16, 2023

(54) CUTTING UNIT FOR INDUSTRIAL SECTORS EQUIPPED WITH TORQUE MOTOR

(71) Applicant: Attilio Cavagna, Boffalora d'Adda (IT)

(72) Inventor: Attilio Cavagna, Boffalora d'Adda (IT)

(21) Appl. No.: 17/876,122

(22) Filed: Jul. 28, 2022

(30) Foreign Application Priority Data
Jul. 28, 2021 (IT) 102021000020174

(51) Int. Cl. B26D 5/08; B26D 1/15

(52) U.S. Cl. CPC B26D 5/086; B26D 1/151

(57) ABSTRACT

A cutting unit (10) for industrial sectors, especially suitable for cutting of flexible or semi-rigid materials such as paper and cardboard, non-woven fabric, spunbond, spunlace and the like into strips of various widths, intended for example for the manufacture of hygienic products such as nappies, sanitary towels, face masks, as well as tissue, tape, packaging and cardboard cores, comprising a supporting structure or casing (12) paired with a flange (14) for supporting the cutting tool (16) consisting of a ring. That said motor is of the torque type in which the rotor (18) and the stator (20) are housed in a seat made along the front face of the casing (12) which is also provided with a housing (28) inside which the control drive (30) of said motor is positioned.

The present invention relates to a rotary cutting unit for industrial sectors equipped with a torque motor.

More particularly, the present invention relates to a cutting unit as defined above, especially suitable for cutting flexible or semi-rigid materials such as paper, cardboard, non-woven fabric, spundbon, spunlace and the like; such materials are used in various sectors, for example for the production of hygienic products such as nappies, sanitary towels, face masks, as well as tissue, tape, packaging and cardboard cores, production of bags, protective sheets, medical clothing, wet wipes and packaging.

As is known, longitudinal cutting into strips of flexible or semi-rigid ribbon materials such as those above, as well as cutting of paper, films of various kinds and technical materials, are carried out at an industrial level through specific apparatuses provided with various units, aligned on guides and spacable out from each other according to the width of the strips to be obtained from the material being unwound from one or more reels. Each of the cutting units typically comprises a rotary blade and an underlying counter-blade, also rotary too; pneumatic actuation devices are provided to determine the precise positioning between the blade and the counter-blade according to the thickness of the material to be cut.

Currently, the rings or cutting units are moved in rotation by means of compact AC electric motors, in relation to which some important drawbacks have been noted. Such motors, in fact, allow torque only at a high number of revolutions; to start cutting, the blades from the beginning rotate at a high speed, increasing the risk of injury when the equipment on which they are mounted starts. Said AC motors work smoothly generally starting from 800 m/min, but at this speed also the problem of their overheating manifests itself, which can lead to malfunctions, appreciably reducing their useful life; a lack of torque can also occur, resulting in the difficulty or inability to cut in narrow strips tenacious materials with high weights.

In addition, these well-known motors are controlled by drives installed inside switchboards separate from the equipment and placed at a considerable distance from the motors themselves, with the result that signal disturbance problems easily occur. Moreover, low torque and overheating do not permit use on low-speed machines.

From WO 2016 157067 a device for cutting a layer of material, performed with a single blade and without a counter-blade, in which a cutting edge is suspended in a cavity of the working surface, is known. In WO 2007 130292, a food slicer and the method with related means for cutting the product by rotary a blade is described. In WO 2010 073269, a device for shearing materials is disclosed in which there are two side-by-side circular blades acting one after the other on the material to be sheared.

The purpose of the present invention is to obviate the above-mentioned drawbacks.

More specifically, the purpose of the present invention is to provide a cutting unit equipped with a motor capable of delivering constant torque from low speeds up to the maximum allowable RPM, thereby averting the danger of injury when the equipment starts.

A further purpose of the invention is to provide a cutting unit in which the motor in question, due to the fact that it can work optimally even at a limited number of revolutions, is not subject to the risk of overheating.

Last but not least, the purpose of the invention is to provide a cutting unit in which the related motor integrates the control drive, which makes it possible to reduce the overall dimensions and to have only one power cable reaching the motor itself; the need for a large electrical cabinet is also avoided and the wiring as a whole is simplified.

A further purpose of the invention is to provide a cutting unit that can achieve very small cutting widths according to its overall dimensions of less than 50 mm.

A further purpose of the invention is to provide a cutting unit free from drawbacks related to possible signal disturbances between motor and drive.

These and other purposes are achieved by the cutting unit for industrial sectors equipped with a torque motor of the present invention in accordance with the main claim.

The constructional and functional features of the cutting unit of the present invention may be better understood from the following description, in which reference is made to the attached tables of drawings which represent a preferred and non-limiting embodiment and in which:

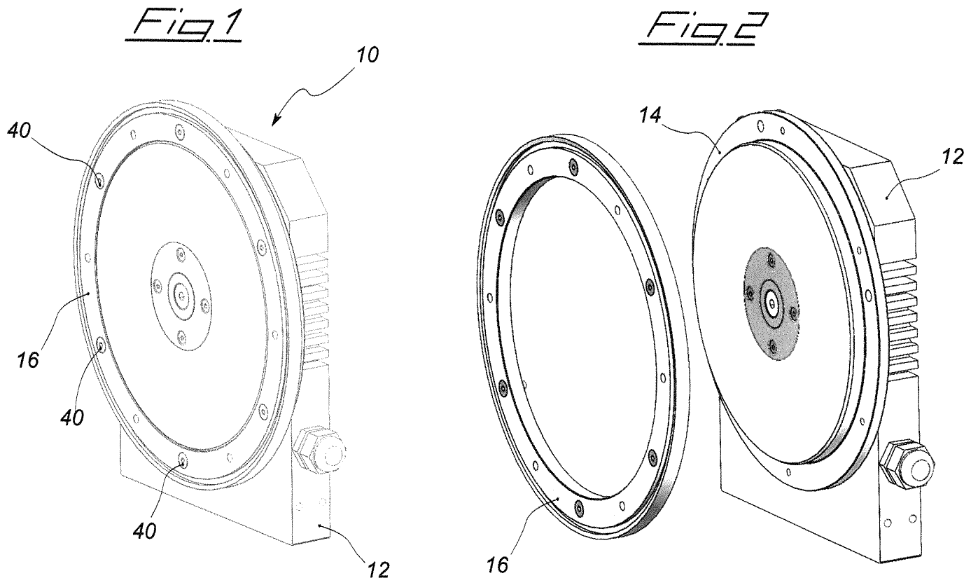

FIG. 1 schematically represents, in axonometric view, the cutting unit of the present invention assembled into its components;

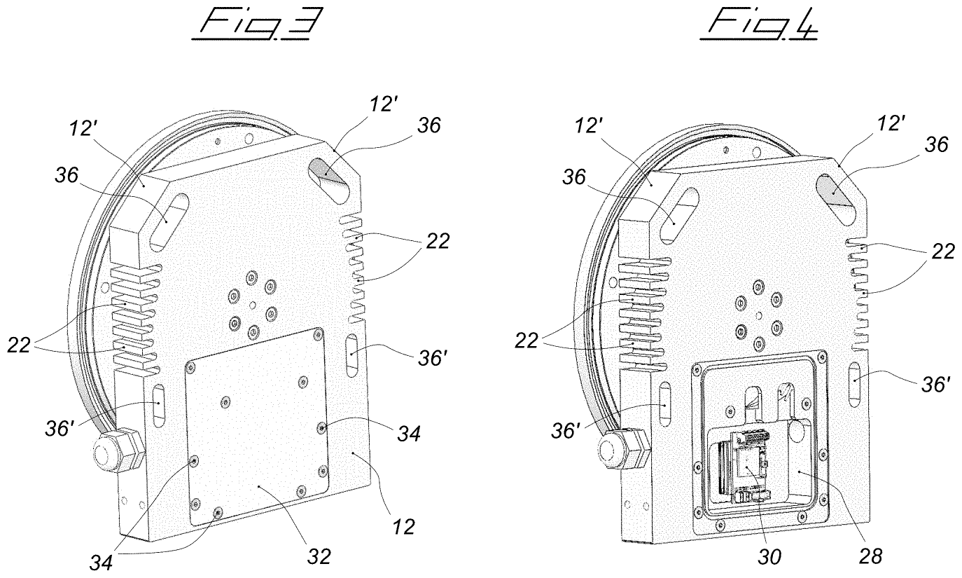

FIG. 2 schematically represents, in exploded view, the motor casing of the cutting unit of the present invention and the cutting tool;

FIG. 3 schematically represents, in axonometric view from the back face, the cutting unit according to FIG. 1;

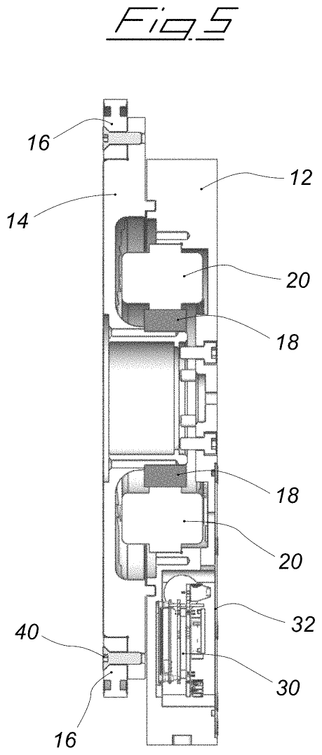

FIG. 4 schematically represents, in axonometric view from the back face, the cutting unit according to FIG. 1, to highlight the seat formed into the casing for receiving the motor management drive;

FIG. 5 schematically represents, in longitudinal section, the cutting unit of the present invention.

With reference to the mentioned figures, the cutting unit for industrial sectors equipped with a torque motor of the present invention, shown as a whole with 10 in FIG. 1, includes a supporting motor structure or casing 12 coupled with a flange 14 that forms the support for the cutting tool, shown with 16 and consisting of a ring.

According to the invention, the casing 12, made of aluminum and substantially in the shape of a rectangular parallelepiped with upper vertices 12′ bevelled, is provided with an annular housing for a torque motor, comprising a rotor 18 and a stator 20; at the opposing flanks, the casing 12 defines a plurality of grooves that materialize superimposed fins 22, aimed at favouring dissipation of the heat developed by the motor. A flange 24, coupled to the front face of casing 12, to which it is connected by screws 26 or equivalent means, partially houses rotor 18 and stator 20, stabilizing them.

On the opposite back face, the casing 12 is provided with a housing 28 within which the motor control drive 30 is advantageously arranged; the housing 28 is closed by a panel 32, arranged flush with the casing 12 to which it is attached by screws 34. A through opening 36 is formed at each of the upper bevelled vertices 12′ of the casing 12, and similar openings 36′ are made at lower positions, e.g., at the sides of the housing 28; these openings, as well as the fins 22, have the function of dissipating heat. The flange 24 coupled to the casing 12 forms the support for the cutting ring 16; in this regard, an annular recess 38, visible particularly in FIG. 2, is formed peripherally on said flange to form the seat for the aforementioned shear ring. The latter, once fixed with screws 40 to the casing 12, remains flush with the lower face of said casing, with respect to which it protrudes only above in order to strike the material and make the required cut on it. The overall dimensions of the cutting unit 10 as a whole, measured from the front face of the flange 14 housing the cutting ring 16 to the rear face of the casing 12 housing the panel 32, is advantageously less than 50 mm.

As can be noted from the foregoing, the advantages that the invention achieves are obvious.

The cutting unit for industrial sectors equipped with a torque motor of the present invention is provided with a motor capable of delivering constant torque from low speeds up to the maximum allowable RPM, thus avoiding the danger of possible injury when the equipment starts. In addition, the motor with which the cutting unit of the invention is equipped can work optimally even at a limited RPM and is not subject to the risk of overheating, and the fins 22 formed on the casing 12 allow an optimal heat dissipation, so that the working temperatures remain limited, according to experimental tests carried out by the applicant, at a level not exceeding 50° C. Further advantageous is the fact that the casing 12, flange 14 assembly defines an overall dimensions in depth of less than 50 mm, a size traditionally obtained only by means of AC motors; in this case, thanks to the use of a torque motor with a casing 12 incorporating the control drive 30, the assembly is particularly compact, there is only one power cable reaching the motor, and problems of signal disturbances are excluded since the distance between the motor and the control drive is practically zero. Very small cutting widths can also be achieved, depending on said overall dimensions of less than 50 mm.

Although the present description relates to an exemplary embodiment, those skilled in the art will recognize that modifications and additions can be made to form and details without departing from the object of the claimed subject matter. For example, in relation to one or more features which offer one or more advantages, it is to be expected that they can be exchanged with each other or alternatively combined with each other in the exemplary embodiments or in other alternative embodiments. The present description is manifestly intended to be as broad as possible whereby, in the absence of different specific notes, claims comprising a single particular element also apply to a plurality of such particular elements.

1. A cutting unit (10) for industrial sectors, especially suitable for cutting flexible or semi-rigid materials such as paper and cardboard, non-woven fabric, spunbond, spunlace and the like into strips of various widths, intended for example for the manufacture of hygienic products such as nappies, sanitary towels, face masks, as well as tissue, tape, packaging and cardboard cores, comprising a supporting structure or casing (12) paired with a flange (14) for supporting the cutting tool (16) consisting of a ring, characterised in that said motor is of the torque type in which the rotor (18) and the stator (20) are housed in a seat made along the front face of the casing (12) which is also provided with a housing (28) inside which the control drive (30) of said motor is positioned.

2. The cutting unit according to claim 1, characterized in that said casing (12), substantially in the shape of a rectangular parallelepiped with upper bevelled vertices (12′) defines, on opposite sides, a plurality of grooves forming superposed fins (22) suitable to favour the dissipation of the heat developed by said motor.

3. The cutting unit according to claim 2, characterized in that it comprises on the casing (12) through openings (36, 36′) suitable to favour the dissipation of the heat developed by said motor.

4. The cutting unit according to claim 1, characterized in that a flange (24) is coupled with the front face of the casing (12) constituting the support for a cutting ring (16) fixed to said flange with screws (40).

5. The cutting unit according to claim 3, characterized in that the flange (24) is provided, on the exposed front face, with a peripheral annular recess (38), suitable to form the housing seat for said cutting ring (16).

6. The cutting unit according to claim 3, characterized in that the flange (24) is fixed to the front face of the casing (12) with screws (26) or equivalent means.

7. The cutting unit according to claim 1, characterized in that the housing (28), inside which the control drive (30) of said motor is positioned, is closed by a panel (32) arranged flush with the casing (12) to which it is fixed with screws (34).

8. The cutting unit according to claim 1, characterized in that it defines an overall size, measured from the front face of the flange (14) housing the cutting ring (16) to the rear face of the casing (12) housing the panel (32), of less than 50 mm.

9. The cutting unit according to claim 2, characterized in that it defines an overall size, measured from the front face of the flange (14) housing the cutting ring (16) to the rear face of the casing (12) housing the panel (32), of less than 50 mm.

10. The cutting unit according to claim 3, characterized in that it defines an overall size, measured from the front face of the flange (14) housing the cutting ring (16) to the rear face of the casing (12) housing the panel (32), of less than 50 mm.

11. The cutting unit according to claim 4, characterized in that it defines an overall size, measured from the front face of the flange (14) housing the cutting ring (16) to the rear face of the casing (12) housing the panel (32), of less than 50 mm.

12. The cutting unit according to claim 5, characterized in that it defines an overall size, measured from the front face of the flange (14) housing the cutting ring (16) to the rear face of the casing (12) housing the panel (32), of less than 50 mm.

13. The cutting unit according to claim 6, characterized in that it defines an overall size, measured from the front face of the flange (14) housing the cutting ring (16) to the rear face of the casing (12) housing the panel (32), of less than 50 mm.

14. The cutting unit according to claim 7, characterized in that it defines an overall size, measured from the front face of the flange (14) housing the cutting ring (16) to the rear face of the casing (12) housing the panel (32), of less than 50 mm.
